(19) United States
(12) Patent Application Publication
(10) Pub. No.: US 2010/0062966 A1
(43) Pub. Date: Mar. 11, 2010

(54) SELF-CLEANING THIN-FILM FORMING COMPOSITIONS

(75) Inventors: David Lincoln, Webster, NY (US); Susan Lincoln, Webster, NY (US)

Correspondence Address: BUCHANAN, INGERSOLL & ROONEY PC, POST OFFICE BOX 1404, ALEXANDRIA, VA, 22313-1404, US

(73) Assignee: Novipella, Inc., Webster, NY (US)

(21) Appl. No.: 12/554,222

(22) Filed: Sep. 4, 2009

Related U.S. Application Data
(60) Provisional application No. 61/136,499, filed on Sep. 9, 2008.

(51) Int. Cl. C11D 1/72

(52) U.S. Cl. 510/466; 510/506

(57) ABSTRACT

Compositions for various surfaces including glass, metals, ceramics, polymers, painted surfaces, and other durable non-porous materials clean surfaces while forming a durable, and long-lasting residual thin film. The thin film is self-cleaning, and can be self-disinfecting. The compositions include a combination of a surfactant and a nanoparticulate photocatalytic material (e.g., metal oxide), and may comprise additional elements such as antioxidants, perfumes, and disinfecting agents

### TECHNICAL FIELD

The technical field is cleaning compositions for durable porous and non-porous materials. More particularly, hydrophilic thin-film coating compositions capable of effecting photocatalytic-based cleaning activity.

### BACKGROUND

Surfaces coated with a composition comprising a semiconductor photocatalyst can exhibit an effect termed “superhydrophilicity.” See, e.g., U.S. Pat. No. 6,013,372, incorporated herein by reference. Upon irradiation by light having a wavelength of energy higher than the bandgap energy of the photocatalyst, water is chemisorbed onto the surface in the form of hydroxyl groups whereby the surface of the photocatalytic coating is rendered highly hydrophilic. In certain embodiments, it has been reported that sunlight can provide sufficient irradiation. E.g., U.S. Pat. No. 6,013,372; see also “Discovery and Applications of Photocatalysis-Creating a comfortable future by making use of light energy” JAPAN NANONET BULLETIN—44th Issue—May 12, 2005. When properly formulated and applied, and in appropriate environments, such coating compositions effect a high degree of antifogging, and can effect sustained self-cleaning. When articles coated with such compositions are exposed to water, the composition can cause fatty dirt and other contaminants to be released from the surface without resort to a detergent.

Surfaces coated with such compositions demand a high degree of uniformity in coating thickness, appearance, etc. For example, differences in refractive index between the coating and the substrate can produce interference colors, producing visual incontinuities detracting from the product's appearance, e.g., streaks on windows. Accordingly, surfaces coated with such compositions are manufactured by expensive coating methods requiring specialized equipment, e.g., chemical vapor deposition (CVD), spray-coating, dip-coating, hand coating, flow-coating, spin-coating, roll-coating, and brush-coating, followed by drying and/or firing. Compositions requiring such coating methods are impractical for household use, and thus have not achieved wide-scale retail commercialization.

Environmental cleanliness of living space is an increasingly important issue. Products coated with or containing titanium dioxide have been proposed for improved hygienic conditions, and the use of titanium dioxide as a cleaning agent, for both interior and exterior applications, is generally accepted. Certain thixotropic compositions are purportedly capable of forming photocatalytic films that are super hydrophilic, durable, and self-cleaning. WO/2005/066286/EP1702011 METHOD FOR TREATING SURFACES describes the creation of a photocatalytic composition by applying a powder or a concentrated suspension of titanium dioxide on a surface. The compositions are formulated such that thixotropic or thickening properties of the composition permits formation of a photocatalytic film on standing, and the excess are wiped off. It is difficult to form consistent, even thin films with such compositions, and so they do not afford a clean, attractive, transparent, and uniform surface as demanded by the consumer. Further, such compositions produce excessive waste material that must be properly disposed.

In addition, keeping glass clean and shiny significantly enhances the appearance of a home or a car. A popular method of cleaning glass is by applying a glass cleaning composition on the surface of the glass and wiping it off using soft, clean and lint-free clothes or towels. Conventional cleaning compositions are formulated to remove dirt and soils from the glass surface, wherein the dirt and soils may comprise either organic or inorganic substances, or a mixture of both leaving streak and water spot free. Many glass-cleaning products are sold commercially, which typically contain a surfactant, an organic solvent or solvent system, a pH-adjusting agent such as ammonia or acetic acid, a detergent builder, a hydrotrope, a fragrance, a dye, and water. WINDEX® and GLASS PLUS® are representative commercially available products. These products do not self clean and are formulated using chemical synthesized components and do not use natural products which are necessary for new “green” formulated products.

There remains in the marketplace great demand for self-cleaning and “green” compositions suitable for household application that meet demanding visual and clarity requirements.

### SUMMARY

Compositions having a semi-conductor component, for example, particles of a metal oxide (e.g., titanium dioxide, silicon oxide, zirconium oxide, and/or aluminum oxide) can be formulated to exhibit photocatalytic activity. Such compositions are formulated to facilitate the formation of durable, consistent thin films without the need for specialized equipment and that can be used in many different applications on a wide variety of surfaces.

The compositions form thin films that effect mineralization of organic material through photocatalytic processes. The mineralization process decomposes organic material that acts as a binder holding inorganic materials (dirt) on surfaces. In one embodiment, nanocrystalline titanium dioxide (DeGussa/Evonik) is compounded so as to form a durable, long lasting thin film coating on the surface of a substrate. Such thin films are sufficiently durable that they are suitable for interior or exterior application.

The compositions of the instant invention, among other things, exhibit self-cleaning and self-disinfecting properties when applied to a variety of surfaces. Exemplary surfaces are metals, ceramics, and glasses, as well as durable polymers and painted surfaces; although virtually any solid surface capable of accommodating a thin film can be used. Alternatively, the compositions can be deployed as a mixture with other coatings or film-forming materials, e.g., paints, varnishes, and polymers.

The instant compositions reduce or eliminate contamination by living and non-living materials (e.g., microorganisms such as viruses, bacteria, etc. as well as prions, toxins, and other disease causing agents). The compositions also effect pollution abatement to decompose and remove pollutants in air, water and on surfaces. These compositions afford continuous and improved cleaning and disinfection in a composition that is durable, long-lasting, and virtually invisible.

### BRIEF DESCRIPTION OF THE FIGURES

Features of the invention are set forth in the appended claims. The exemplary embodiments may best be understood by reference to the following description taken in conjunction with the accompanying drawings. In the figures, like referenced numerals identify like elements.

FIG. 1 illustrates a mechanism for focusing of light on a surface to produce a photocatalytic response.

FIG. 2 illustrates photocatalytic response and mineralization of organic materials to inorganic materials on a surface, showing a way to clean a surface using light without a detergent.

FIG. 2a illustrates the photocatalytic mineralization reaction that will clean a surface without detergent.

FIG. 3 illustrates the photocatalytic mineralization reaction that will clean a glass surface without a detergent on a glass surface.

FIG. 4 illustrates a water droplet contact angle on a non-photocatalytic surface.

FIG. 5 illustrates a water film and its contact angle on a photocatalytic surface.

FIG. 6 is a flow diagram of a cleaning process and system using a photocatalytic method on a glass surface.

FIG. 7 is a scanning electron microscope (SEM) image of a hand-applied photocatalytic film on glass.

FIG. 8 is a (SEM) image of Sun Clean™ Self Cleaning Glass photocatalytic film.

FIG. 9 is an analysis of coated Titanium using Energy dispersive X-ray spectroscopy (EDS) on a hand-applied photocatalytic film on glass.

FIG. 10 is an analysis of coated Titanium using Energy dispersive X-ray spectroscopy (EDS) on Sun Clean™ Self Cleaning Glass photocatalytic film on glass.

### DETAILED DESCRIPTION

In the following description, reference is made to the accompanying drawings, which form a part hereof. The description and the drawings illustrate specific exemplary embodiments by which the invention may be practiced. These embodiments are described in sufficient detail to enable those skilled in the art to practice the invention. It is understood that other embodiments may be utilized, and other changes may be made, without departing from the spirit or scope of the present invention. The following detailed description is therefore not to be taken in a limiting sense, and the scope of the present invention is defined by the appended claims.

Throughout the specification and claims, the following terms take the meanings explicitly associated herein unless the context dictates otherwise. The meaning of “a”, “an”, and “the” include plural references. The meaning of “in” includes “in” and “on.” A reference to the singular includes a reference to the plural unless otherwise stated or inconsistent with the disclosure herein.

According to various embodiments as contemplated by the inventors, and as disclosed herein, compositions and methods are provided for effecting durable and long-lasting photocatalytic-based cleaning activity. The cleaning activity may be effected by creating a thin-film on a surface and/or by mixing the composition with other surface treatments such as paints, varnishes, polymers, and the like, and/or by mixing the composition with the structural matrix itself (e.g., ceramics and polymers). The resulting compositions eliminate existing dirt and contamination, and resist the establishment of further build up or contamination.

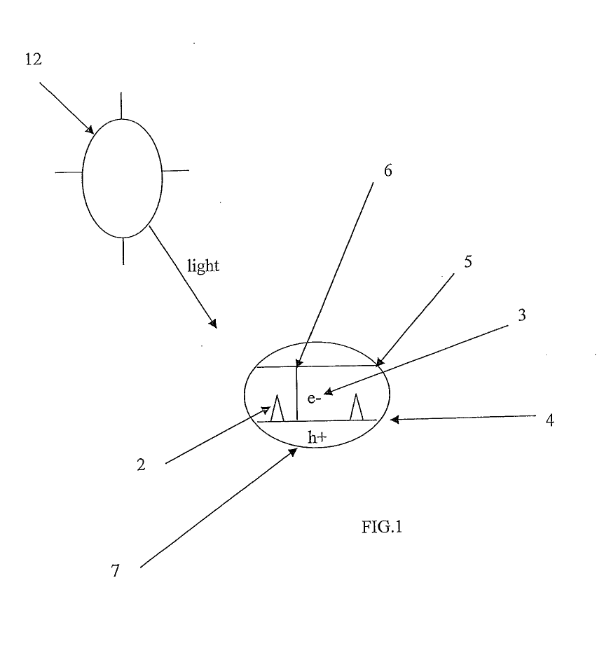

During the photocatalytic process, as illustrated in FIG. 1, the semiconductor 2 is exposed to a light source causing electrons 3 to transfer from the valence band 4 to the conduction band 5. For this photochemical event to take place, the energy supplied by the light source should be equal to or higher than the band gap 6 of the semi-conductor photocatalyst. This generates a positive hole (h+) 7 in the valence band due to loss of an electron and a lone electron and the conduction band gains an electron. Those electrons participate in the photocatalytic cleaning process.

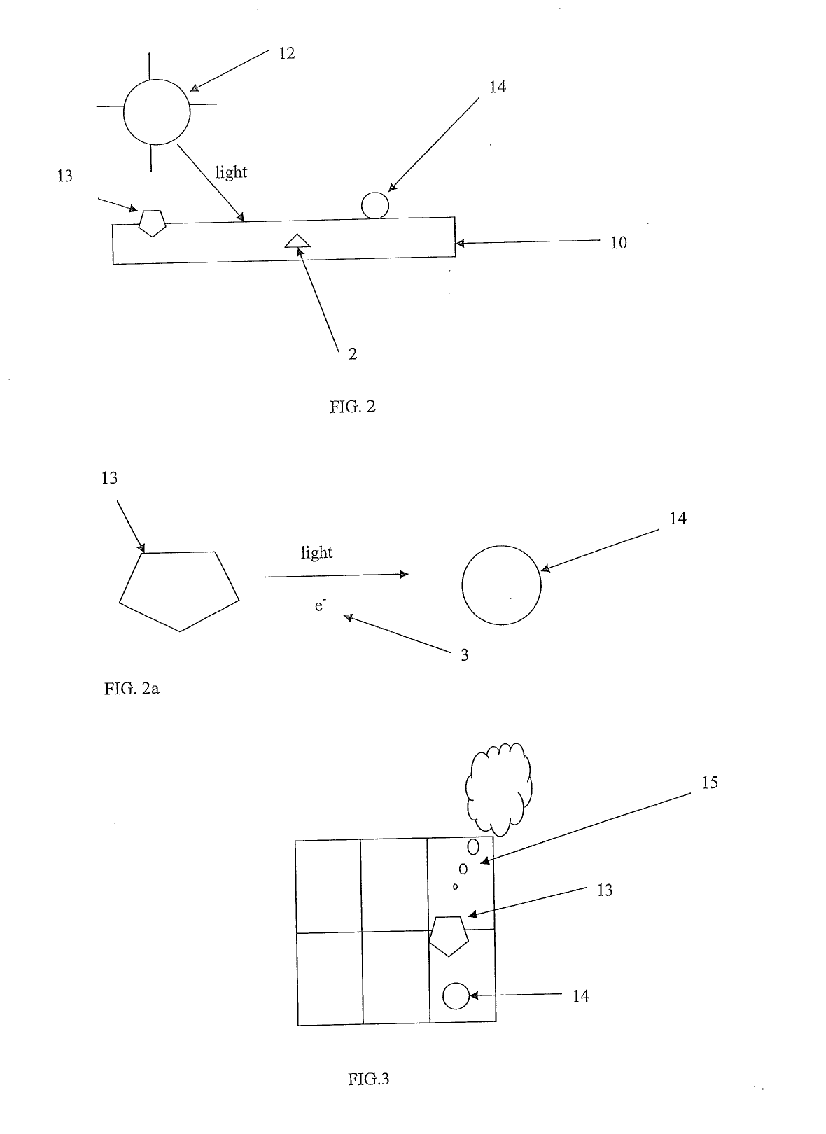

FIG. 2 illustrates a photocatalytic self-cleaning surface 10 containing a semiconductor catalyst 2. The catalyst can function by a photocatalytic decomposition effected by light irradiation 12, particularly in the visible range (e.g., from the sun or man-made sources). Cleansing occurs by the photocatalytic decomposition of organic component 13 and/or mineralization of organic component to an inorganic component 14.

FIG. 2a schematically illustrates the action of electrons 8 in mineralizing the organic component 13 to the inorganic component 14, also referred to herein as mineralization.

FIG. 3 schematically illustrates the role additional solvents or cleansing agents 15, such as rainwater, can play in washing away the mineralized or inorganic component, since organic components 13 can act as a binder holding inorganic components 14 on the surface. The instant self-cleaning surfaces have the added beneficial property of enhanced wash-off due to the effect the modified surface has on the surface tension of water. This property has been called superhydrophilicity. In addition forming a self-cleaning glass surface is to create a micro-rough or micro-structured glass surface. Surface structures of this type feature regular or irregular peaks and valleys of 0.1 micron or greater. Depending on the surface treatment of the structured surface, the structuring can have various effects. When the surface is treated with a hydrophobic agent, the structuring tends to reduce the adhesion of water and solids and create a self-cleaning surface, called a super-hydrophobic surface. When the surface is hydrophilic, the structuring tends to aid in wetting of the surface, creating a super-hydrophilic surface

FIG. 4 schematically illustrates a droplet of water 15 as it appears on an untreated surface 17. The contact angle of the water droplet 16 is the angle at which a liquid/vapor interface meets the solid surface. The contact angle is specific for any given system and is determined by interactions across the surface.

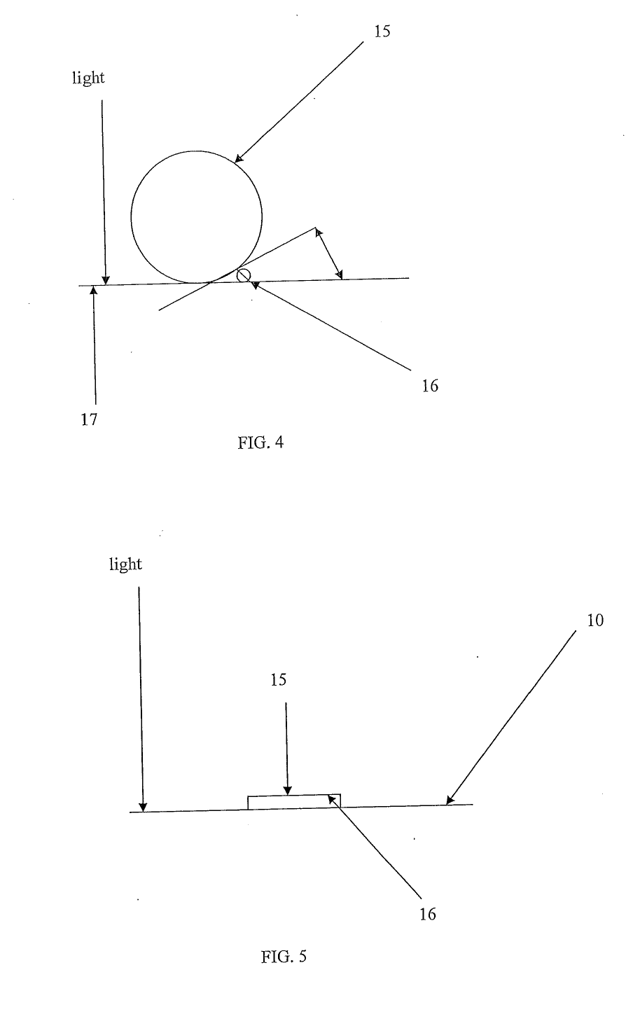

FIG. 5 schematically illustrates that under light irradiation, water 15 dropped onto a semiconductor surface 10 for example titanium dioxideforms a film and has almost no contact angle 16 (˜0°) as compared to an untreated surface 17, depicted In FIG. 5.

The finely divided semi-conductor component, may be an oxide, particularly a metal oxide (e.g., titanium dioxide, silicon oxide, zirconium oxide, and/or aluminum oxide). The semi-conductor component exhibits photocatalytic activity, and the coating enables a variety of applications in a variety of fields. Titanium dioxide particles when formulated in a suitable suspension form superior films on surfaces, which exhibit significant photocatalytic activity.

In one embodiment, there is provided a method for treating surfaces with a composition comprising a thin film nano-crystalline titanium dioxide coating that affects mineralization of organic material through the photocatalytic processes. The composition can be formulated as an aqueous or an oil suspension. Such suspensions afford substantial advantage in that the compositions can be applied by hand without added machinery or special treatment. The suspension can be applied to the surface, and the excess readily removed, as by rinsing or washing the surface. After physical removal, such as rinsing or wiping, a durable photocatalytic thin film results.

In one embodiment, a material for applying and creating the semiconductor thin film is by simple application and polishing or buffing with a micro-fiber or nano-fiber applicator. Such applicators are commercially available in various forms, such as cloths. In its more common commercial form, microfiber is a blend of polyester and polyamide. Microfiber fabrics are exceptionally soft and hold their shape well. When high quality microfiber is combined with the right knitting process, it creates an extremely effective cleaning material that can hold up to seven times its weight in water. Microfiber applicators also have the advantage of high capacity for absorption of oils.

In various embodiments, the compositions of the present invention afford a photocatalytic, dirt repellent, and superhydrophilic layer on the treated surface. Surfaces so treated are advantageous in effecting a change in the surface tension of water droplets on the film. The surface tension of water is reduced such that water droplets form a film that more effectively removes dirt. At the same time, the film-forming effect reduces visual distortion associated with droplet formation, and so visual clarity of such surfaces is enhanced on exposure to rain and the like.

The microfiber applicator material can be microfilaments and so-called “ultra-microfibers”, or nanofibers such as those commercially available from ULINE Corporation (www.uline.corn) and Microfibertech (www.microfibertech.com). Such materials comprise fibers and filaments of polyamide and polyester, and are superior in many ways to traditional cleaning materials and fibers due to their small size, structure, and physicochemical properties. In various embodiments, ultra-microfibers are triangular in cross-section, have sharp edges, and have a diameter of approximately three microns.

Dirt particles, including “living” particles comprising microorganisms (e.g., bacteria) typically has a diameter of two to five microns. The extremely small size and structure of the ultra-microfiber allows that fiber to get beneath the bacteria or other small microbes and particles that are smaller than the fiber, and substantially remove them from a surface. Additionally, to improve performance, the microfibers are usually mixed with polyester fibers in a 50/50 ratio in the case of woven material, and a 70/30 ratio of polyester to ultra-microfiber in the case of knitted material.

The cleaning properties of the ultra-microfibers are further enhanced because they have a cationic (positive) charge due to the presence of the polyamide in the ultra-microfibers. Most dirt and dust particles (e.g., bacteria, pollen, oxidation on metals, etc.) have an anionic (negative) charge. Thus, the ultra-microfibers naturally attract negatively charged particles, e.g., bacteria, etc.

In addition to the ultra-microfiber's ability to pick up small particles, the ultra-microfiber has superior absorption properties. The ultra-microfiber's small diameter translates into substantially greater surface area than that found in conventional fibers. The small diameter of the fibers also provides powerful capillary action, which, in addition to pulling in liquid, also pulls in particulates and microbes contained within the liquid. Thus, the combination of the increased surface area and capillary action gives the ultra-microfiber cloth the ability to absorb vast amounts of liquid many times its own weight.

Microfiber also affords transfer of the nano-titanium dioxide particle to the material substrate (e.g., glass, metal, ceramic), thereby facilitating mineralization of organic particles, including living organic particles, by subsequent photocatalytic effects.

Ultra-microfibers may be woven or knitted together to construct a cleaning material. The ultra-microfibers may first be woven or knitted in an un-split form using techniques known in the art. After the material is woven or knitted, such material is then subjected to a chemical and mechanical process that splits the ultra-microfiber into its component filaments. This may be accomplished by using a combination of heat and alkali.

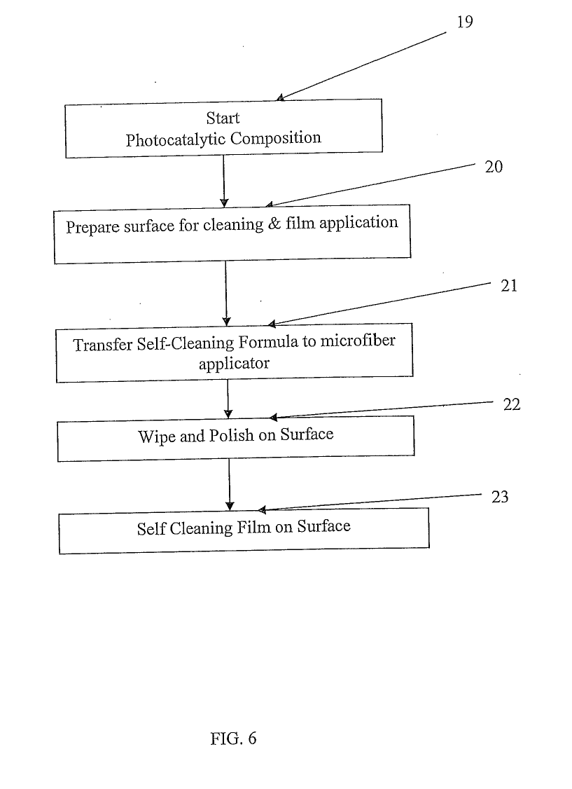

The cleaning system including photocatalytic compositions and microfiber cleaning materials result in effective self-cleaning and self-disinfection FIG. 6.

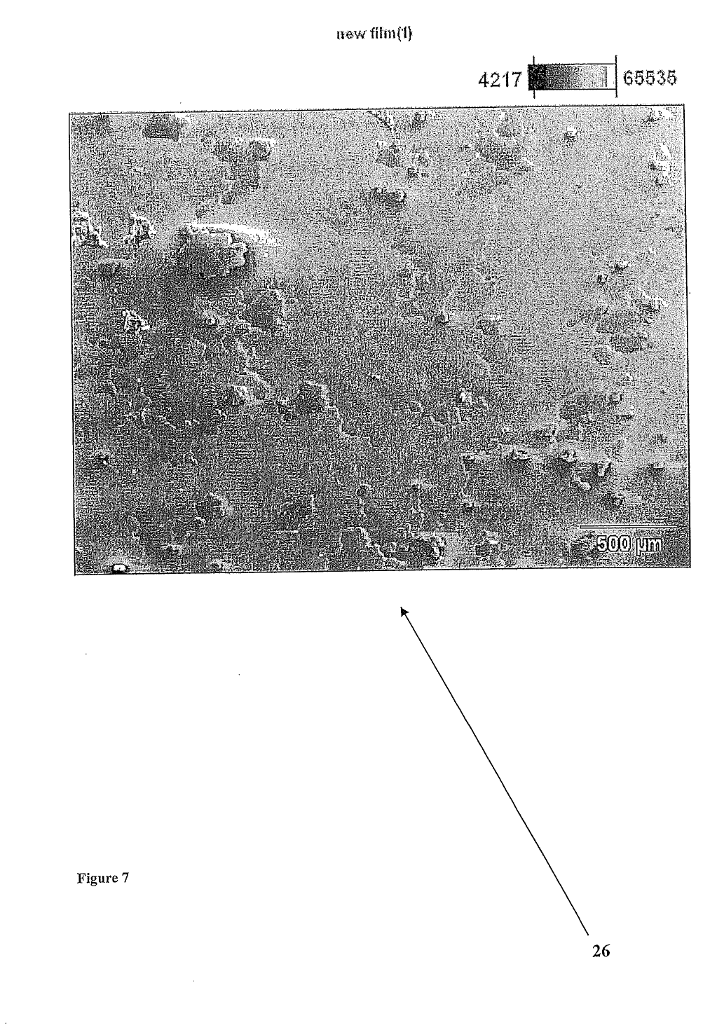

FIG. 7 is a scanning electron micrograph (SEM) image showing the film 26 that has been created by the instant compositions and process as illustrated in flow diagram of FIG. 6.

FIG. 7 has a film thickness of 0.2 nm as determined by a microprobe/SEM technique and comparing the Titanium intensity to the signal of pure Titanium metal. An accelerating voltage was applied while acquiring the SEM image, which penetrated through the films and into the substrate, which determines thickness. The data was entered into a “thin film on substrate” program used to calculate the thickness of the TiO₂ film.

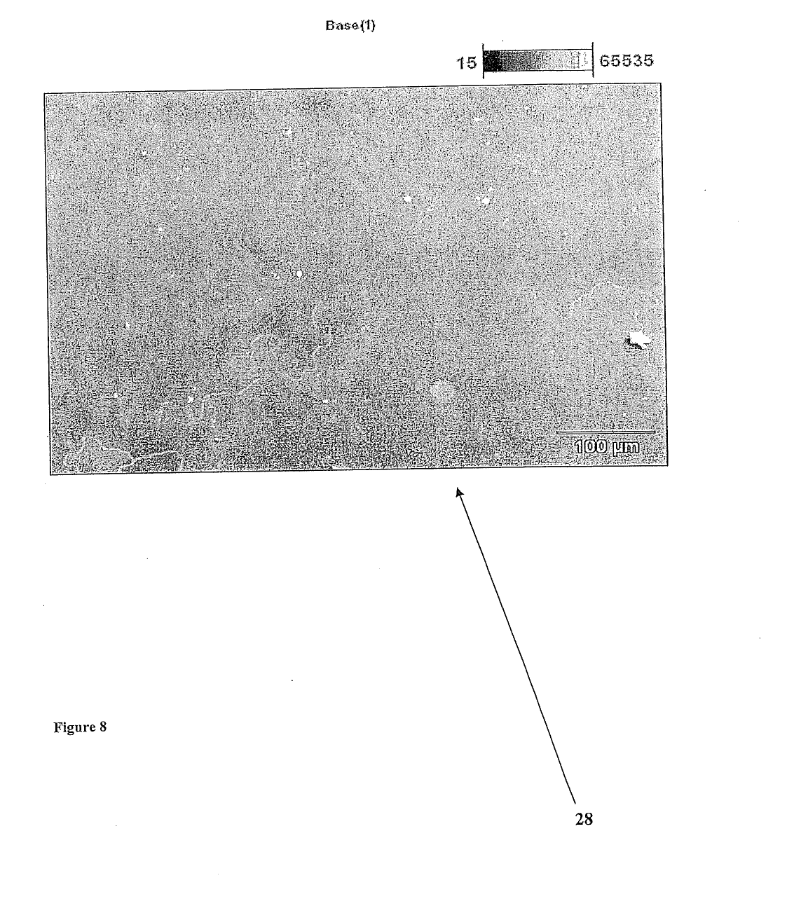

FIG. 8 depicts an SEM image of Sunclean™ Self-Cleaning glass (PPG Industries) that has a film 27 coated glass product with both photocatalytic and hydrophylic properties. A durable, yet expensive, high temperature transparent coating treatment such as a process using Chemical Vapor Deposition is applied to hot glass during the formation process making it an integral part of the outer surface of SunClean™ Self-Cleaning Glass. Using the process as described previously, the thickness of the SunClean™ Self-Cleaning Glass gave a result of about 18 nm.

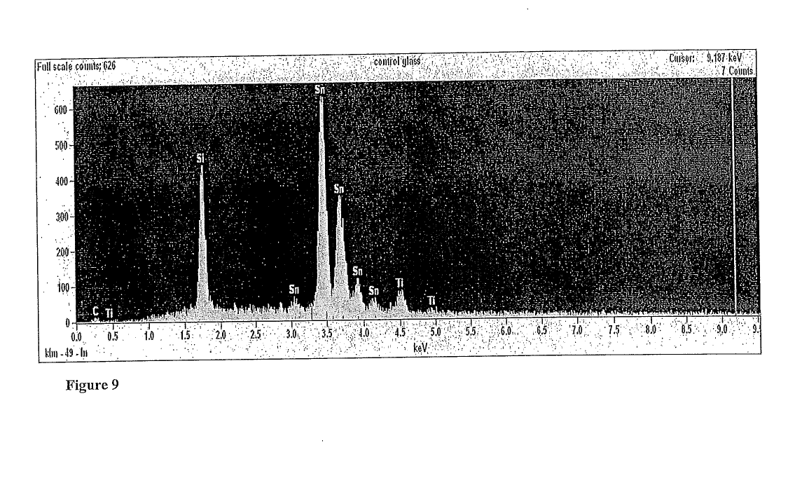

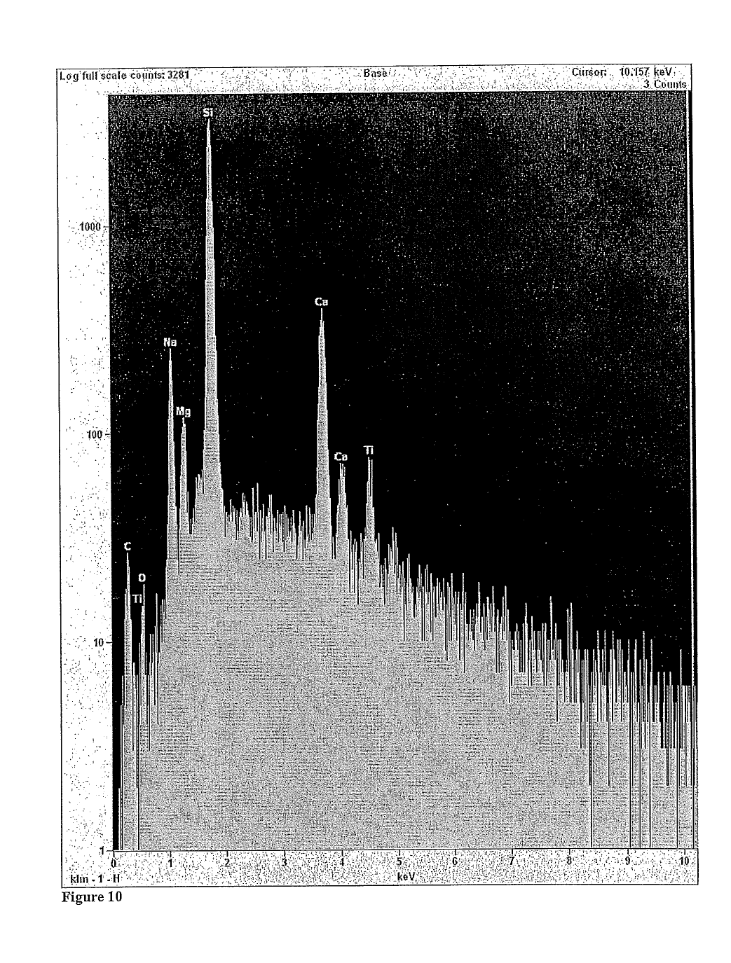

Energy dispersive X-ray spectroscopy (EDS) is an analytical technique used for the elemental analysis or chemical characterization of a sample. As a type of spectroscopy, it relies on the investigation of a sample through interactions between electromagnetic radiation and matter, analyzing x-rays emitted by the matter in response to electromagnetic radiation. Its characterization capabilities are due in large part to the fundamental principle that each element has a unique atomic structure allowing x-rays that are characteristic of an element's atomic structure to be identified uniquely from each other. FIGS. 9 and 10 depict, respectively, an EDS spectrum demonstrating the presence of Titanium in the hand-applied film (FIG. 7), and in Sun Clean™ Self-Cleaning Glass (FIG. 8).

The photocatalytic composition 19 is comprised of semiconductors, surfactants, stabilizers, and colorants that are optimal in coating characteristics such that photocatalytic thin films result and are optimized in self-cleaning. In addition, the semi-conductor formulation is optimized with respect to the surface nanostructure and nano-scale atomic arrangement of the semiconductor. As a result, a thin film adheres to a surface such that even after application of a physical force (e.g., wiping, touching, rinsing or general wear to the environment), a thin film of the semi-conductor formula remains on the surface. As previously described, FIG. 7 illustrates an optimized film surface nanostructure and nano-scale atomic arrangement of titanium dioxide as the photocatalytic semi-conductor.

In the various embodiments of the present invention, photocatalyst include, but are not limited to, TiO₂, ZnO, WO₃, SnO₂, CaTiO₃, Fe₂O₃, MoO₃, Nb₂O₅, Ti_{X}Zr_{(̂X)}O₂, SiC, SrTiO₃, CdS, GaP₅ InP, GaAs, BaTiO₃, KNbO₃, Ta₂O₅, Bi₂O₃, NiO, Cu₂O, SiO₂, MoS₂, InPb, RuO₂, CeO₂, Ti(OH)₄, and combinations thereof. Similarly, the compositions of the present invention can include inactive particles coated with a photocatalytic coating incorporating any of the foregoing photocatalysts. In other embodiments, the photocatalytic particles are doped with, for example, carbon, nitrogen, sulfur, fluorine, and the like. In some embodiments, the transition metal oxide photocatalyst is nano-crystalline anatase TiO₂. Those skilled in the art will appreciate that relative photocatalytic activities of a coated substrate can be determined via a rapid chemical test that provides an indication of the rate at which photocatalysis will occur.

In one embodiment, the photocatalytically active metal oxide powder used is pyrogenic titanium dioxide, which is obtained by flame hydrolysis of TiCl₄. The primary particles of such powders usually have a size of from about 15 nm to about 30 nm. A commercial source of the described titanium dioxide is Peroxide TiO₂ P25, (Source: Degussa). The nano-titanium dioxide according to the invention may be in rutile or anatase form or in the form of a mixture of the two forms. When pyrogenically prepared titanium dioxide powders are used, rutile and anatase modifications are generally present. The anatase/rutile ratio may widely vary, and the range can be from 2:98 to 98:2. In one embodiment, the range may be from 70:30 to 95:5. Anatase has a lower hardness compared to rutile. Rutile, on the other hand, has a higher refractive index and better resistance to weathering.

In addition, the metal oxide (e.g., TiO₂) can be modified to enhance its photocatalytic activity and thin-film forming properties. Such modification includes surface treatments with an organosilane. In one embodiment, the organosilane is an alkoxyalkyl silane. In another embodiment, the organosilane is trimethoxy octyl silane. Such surface treatment of the metal oxide can increase the hydrophobic characteristics of the metal oxide (e.g., TiO₂), and enhance UV light absorption and/or attenuation.

In another aspect, the invention may contain a hydrophilic pyrogenic derived silica (SiO₂) for creating and/or promoting a self-cleaning surface, antisetting, dispersion aid, free flow agent, reinforcing agent, thermal stability agent and thickening/thixotropy additive. In one embodiment, the silica is Aerosil 200 (www.aerosil.com, Degussa Corp.).

In various embodiments, the compositions of the invention comprise surfactants. Surfactants incorporated in the photocatalytic composition 19 can enhance effective dispersion, and thereby enhance the film-forming effect of the aqueous TiO₂ dispersions. Control of the TiO₂ slurry viscosity, viscoelastic properties, effective particle size, and sedimentation rate of the individual TiO₂ particles may be achieved by modifying, altering, or selecting the molecular structure of the surfactant. For example, the use of linear alkoxylated alcohols, e.g., Pareth 25-7 or Surfonic L24-7 (Source: Huntsman), or alkyl polyglycoside surfactants, e.g., Glucopon 425N (Source: Cognis Corporation), act as effective dispersants for aqueous nano-TiO₂ dispersions. Those surfactants are considered nonionic, and thus do not have to be used in alkaline media, which can alter photocatalytic response. In addition, naturally derived alkyl polyglycoside surfactants are generally accepted as non-toxic and having a good health and safety profile, i.e., orally non-toxic, and non-irritants to the skin and eyes.

Alternatively, any aqueous or aqueous-miscible solvent may be used, with or without surfactants. A great many surfactants are commercially available, and selection of the particular surfactant is not critical. Examples of suitable surfactants include, but are not limited to, linear alkoxylated alcohols, e.g., Pareth 25-7 or Surfonic L24-7 (Source: Huntsman), alkyl polyglycoside surfactants, e.g., Glucopon 425N (Source: Cognis Corporation), and combinations thereof. In one embodiment, the metal oxide is nanocrystalline TiO₂.

A wide range of other surfactants can be formulated into the composition. One or more surfactants can be included in the composition to provide cleaning and solubilization of the other components present in the composition. The surfactants can be amphoteric, anionic, nonionic, or a mixture thereof. Such surfactants may be selected from a group of surfactants that enhance the cleaning performance of the composition without causing or promoting streaking.

Amphoteric surfactants suitable for use include, for example, betaines, alkyl imidazolines, cocoamphopropionates, or combinations thereof. When an amphoteric surfactant is utilized, the amphoteric surfactant may be used under alkaline conditions to render the anionic portion of the amphoteric compound active. A suitable amphoteric surfactant is disodium cocoamphodipropionate (also known as cocoimidazoline carboxylate) such as that sold under the tradename MacKAM 2CSF, and may be present in an amount ranging from about 0.01 to about 10%.

Other Suitable nonionic surfactants for use in the composition include alkoxylated alcohols, alkoxylated ether phenols, silicone-based compounds such as silicone glycol copolymers, and semi-polar nonionic surfactants such as trialkyl amine oxides.

Suitable anionic surfactants for use include alkyl sulfates, alkyl benzenesulfonates, alkyl taurates, alkyl sacrosinates, alkyl diphenyloxide disulfonates, alkyl naphthalene sulfonates, alkyl ether sulfates, alkyl ether sulfonates, sulfosuccinates, and other anionic surfactants as known for use in cleaning compositions. The surfactants are typically available as the alkali metal, alkaline earth and ammonium salts thereof. Suitable anionic surfactants are alkyl benzenesulfonates such as sodium dodecylbenzenesulfonate (SDBS) and may be present in an amount ranging from about 0.01 to about 10%.

An amphoteric or non-ionic surfactant, or a combination of both may be used. The one or more surfactants may be present in an amount ranging from about 0.01 to about 95%, and in some embodiments are present at about 80 to about 90%.

In addition to ethylene glycol ether, N-alkyl pyrrolidone and surfactant, one or more additional component can be incorporated in the formulation to enhance the cleaning and/or aesthetic qualities of the cleaning composition. Suitable additional components include pH adjusting agents, hydrotropes, dyes, fragrances, buffers, antimicrobial agents, and the like as known for use in cleaning compositions. Additional components are typically present in small amounts, e.g., below about 5%.

Suitable pH adjusting agents include conventional acids, bases, and salts thereof, such as, ammonia, alkali metal hydroxides, silicates, borates, carbonates, bicarbonates, citrates, citric acid, or mixtures thereof. The C₂₋₄ alkanolamines includes, but not limited to, monoethanolamine (MEA), diethylaminoethanol (DEAE), aminomethylpropanol (AMP), and aminomethylpropanediol (AMPD). In one embodiment, the cleaning composition of the invention has a pH in the range of about 3 to about 9; in another embodiment, the pH is about 4 to about 6; and in still other embodiments, the pH is about 4.

Sufficient pH modifying agent is incorporated to obtain the desired pH, and should be compatible with the streak-free cleaning aspect of the disclosed formulations. In one embodiment, aqueous ammonia is employed to adjust the pH to the aforementioned range. Generally, the amount of pH modifying agent ranges from about 0.01 to about 2%.

Buffers are also useful optional components of the cleaning composition to maintain pH within a desired range. Such buffers are present in an amount to maintain the pH within the prescribed range, and in various embodiments this may be accomplished at concentrations from about 0.001 to about 1% (weight).

Other optional components include dyes, which may be added in an amount ranging from about 0.001 to about 1%; and perfumes, which may be present in an amount ranging from about 0.001 to about 1% (weight), the amounts being such as to achieve a desired hue or scent, but without compromising the streak-free cleaning performance of the composition.

The compositions of the present invention may be applied to various surfaces as a liquid directly to the surface to be cleaned or by a transfer medium e.g., a cloth, sponge, brush, etc.; or it may be applied as a spray. It may also be stored and/or applied in aerosol form, e.g., by pressurizing the composition in a container.

Embodiments of the instant compositions comprise about 1-95% of a carrier, and in some embodiments, the carrier will be about 80-90%; and about 0.1 to about 70% metal oxide, and in some embodiments, the metal oxide is between about 1-20%. The silicate component can be between 0.0000001% and 95% by weight of the cleaner. In one embodiment, the silicate component is Aerosil 200 SiO₂, and is present at about 0.1% (unless stated otherwise, all percentages are by weight). The carrier can be water and/or a surfactant.

In addition to photocatalytic decomposition of exterior dirt components, the instant compositions can neutralize or decompose interior “pollutants” or undesirable components that commonly adsorb to surfaces such as glass. Some such components can be deleterious to health, and contribute to “Sick House Syndrome” (SHS). Various common household solvents and components of construction materials are contributors to SHS, e.g., Volatile Organic Components (VOC), formaldehyde (HCHO), etc.

The efficiency of non-photocatalytic materials in decomposing or adsorbing VOCs and HCHO decreases over time, and capacity for sustained decomposition and/or adsorption of common pollutants is limited as such materials are inorganic and/or synthetic materials.

The photocatalytic cleansing effect of the instant compositions can be enhanced by addition of antioxidants. Various antioxidants are known and suitable for instant compositions. For example, polyphenols (e.g., tannins, lignins, and flavonoids; flavonoids include flavonols, flavones, catechins, flavanones, anthocyanidins, and isoflavonoids), and steroid-based compounds obtained from natural sources have antioxidant effect, and are known to be effective in deodorization, detoxifying of heavy metals and nicotine, cancer prevention, endocrine disruptor suppression, anti-oxidation, nitrate decomposition, and disinfection of catechin. Such compounds are widely used many consumer products, including beverage, cosmetic, and food products.

Antioxidants are useful in the compositions of the present invention, and demonstrate high capacity for long-term decomposition or adsorption of pollutants and household toxins. The use of such polyphenols in combination with the photocatalytic components of the instant compositions abate film formations on interior surfaces that contribute to SHS. The polyphenols, particularly flavonoids, are particularly useful agents in the compositions of the present invention. An example of a commercially available polyphenol product is P 2215 Grape Polyphenol Powder (Commercial Source: Phytone Ltd.).

Embodiments of the compositions of the present invention thus may further comprise antioxidants. Such embodiments include self-cleaning, thin-film forming compositions comprising about 5 to about 95% of a carrier; about 0.1 to about 30% metal oxide; and about 0.01 to about 5% of an antioxidant. Exemplary antioxidants are polyphenols. Many diverse polyphenols are known for an anti-oxidant effect. Many polyphenols are commercially available, and many are derived from natural sources. Additionally, antioxidants may be chosen from among commercially available biocides, e.g., Dowicil® (75 or 96; Dow Chemical Co.).

In other embodiments, the carrier is water or a surfactant, and present at about 70% to about 90%. The metal oxide may be added in amounts of about 0.5% to about 5%. The antioxidant may be added in amounts of about 0.1% to about 3%.

Various additives to maintain and/or adjust pH of the instant compositions may also be added, and the use of such additives is routine and well within the skill set of the ordinary worker in the field. Acids and bases may be added to adjust pH, and various buffers and the like may be used to adjust and/or maintain the desired pH. In various embodiments, the pH is in the range of about 3 to about 9; and may also be in the range of about 4 to about 6; and may also be about 4.

The instant compositions have excellent facility for forming photocatalytic self-cleaning, clear, abrasion resistant, thin films of photocatalytic TiO₂ on common household glass and ceramic surfaces. If desired, an organic solvent can also be added to improve performance when greases are present. Examples of such solvents are glycol ethers (e.g. propylene glycol). For example, one could use those derived from C₁ to C₆ alcohols and ethylene oxide (e.g., the Cellosolve and Carbitol glycol ethers or those derived from C₁ to C₄ alcohols and propylene oxide (e.g., the Arcosolv propylene glycol ethers Still other solvents include (but are not limited to) monohydric alcohols, such as ethanol or isopropanol, or polyhydric alcohols such as propylene glycol or hexylene glycol. Other standard ingredients can also be added, such as dyes, perfumes, wetting agents, other builders, and the like.

The rate of photo-oxidation of contaminant deposits was estimated by measuring the rate of decrease in the integrated IR absorbance associated with the C—H stretching vibrations of a thin solution-cast film of stearic acid at less than 365 nm (2.4 mW/cm2) or 254 nm (0.8 mW/cm2) irradiation.

The objects of the present invention therefore include providing a hydrophilic thin-film coating compositions capable of effecting photocatalytic-based cleaning activity having:
(a) Desirable self-cleaning characteristics without requiring continual application and manual cleaning;
(b) Which can be rinsed off and dried without leaving readily visible films, streaks or spots;
(c) Which is relatively inexpensive to produce and easy to use;
(d) Which works in a wide variety of conditions, e.g., temperature and pH; and
(e) Which uses environmentally acceptable, biodegradable, components without harsh chemicals.

These and still other objects and advantages of the present invention (e.g. methods for using such cleaners) will be apparent from this description. The description provided herein is merely exemplary. Thus, the description is not to be viewed as limiting the scope of the invention, but rather the claims

### EXAMPLES

A cleaner concentrate was prepared having the following formula:

### Example 1

(Ingredient/Weight %)

| | | |
|---|---|---|
| a. | Deionized Water | 71.3% |
| b. | Perth 25-7 (Surfactant-ethoxylated alcohol) | 21.6% |
| | (CAS-38131-39-5) | |
| c. | Linear Alcohol Alkoxylate | 4.9% |
| | (CAS-37251-67-5) | |
| d. | P 25 TiO₂ (Evonik/Degussa) | 1.96% |
| | (CAS: 13463-67-7) | |
| e. | Dowicil ® 75 (Antioxidant) | 0.150% |
| | (CAS-4080-31-3) | |
| f. | HCl (pH adjuster) | 0.050% |
| | (CAS 7647-01-0 | |
| g. | BHT (Antioxidant) | 0.015% |
| | (CAS 128-37-0) | |

The components were added at room temperature and with stirring to affect a white heavy suspension concentrate. The components were added in the order indicated except for the TiO2, which was added last to the mixture. The TiO2 was added slowly so as not to lose the light white solid from being suspended in the mixture.

The above concentrate was diluted by adding 4 drops to one gallon of water. The water can be from room temperature to 140° F. The sudsy white solution was used to wash windows and hard surfaces by rinsing a micro-fiber cloth in the cleaning mixture, squeezing completely the micro fiber cloth (microfibertech.com) and subsequently using the opposite side of the micro fiber cloth to leave a wet continuous film that dried to produce a self-cleaning and waterspot and streak free surface.

On larger glass surfaces the cleaning mixture was applied with a Micro fiber Mini Window Washer with Squeegee (casabella.com,)

### Example 2

| | |
|---|---|
| a. Glucopon 425N (CAS: 68515-73-1) | 83.3% |
| b. P 25 TiO₂ (Evonik/Degussa) (CAS: 13463-67-7) | 15.0% |
| c. Vinegar 5% V:V (CAS 64-19-7) | 1.6% |

The TiO₂ was added carefully to the Glucopon surfactant carefully so as to not lose the light and dusty white solid before suspension into the mixture; the vinegar component was added dropwise to acidify the mixture slightly and act as a biocide. The same dilution as in Example 1 was used here and in the following examples.

### Example 3

| | | |
|---|---|---|
| a. | Glucopon 425N (CAS: 68515-73-1) | 83.3% |
| b. | P 25 TiO₂ (Evonik/Degussa) (CAS: 13463-67-7) | 15.0% |
| c. | Vinegar 5% V:V (CAS 64-19-7) | 1.4% |
| d. | P 2215 Grape Polyphenol Powder | 0.2% |
| | (Commercial Source: Phytone Ltd.) | |

### Example 4

| | |
|---|---|
| a. Glucopon 425N (CAS: 68515-73-1) | 83.3% |
| b. P 25 TiO₂ (Evonik/Degussa) (CAS: 13463-67-7) | 15.0% |
| c. Vinegar 5% V:V (CAS 64-19-7) | 1.4% |
| d. Aerosil 200 | 0.2% |

### Example 5

| | |
|---|---|
| a. Glucopon 425N (CAS: 68515-73-1) | 83.3% |
| b. P 25 TiO₂ (Evonik/Degussa) (CAS: 13463-67-7) | 10.0% |
| c. Vinegar 5% V:V (CAS 64-19-7) | 1.4% |
| d. Aerosil 200 SiO2 | 5.3% |

### Example 6

| | |
|---|---|
| a. Glucopon 425N (CAS: 68515-73-1) | 93.3% |
| b. P 25 TiO₂ (Evonik/Degussa) (CAS: 13463-67-7) | 2.6% |
| c. Vinegar 5% V:V (CAS 64-19-7) | 1.5% |
| d. Aerosil 200 SiO2 | 2.6% |

### Example 7

| | |
|---|---|
| a. Glucopon 425N (CAS: 68515-73-1) | 93.3% |
| c. Vinegar 5% V:V (CAS 64-19-7) | 1.5% |
| d. Aerosil 200 SiO2 | 5.2% |

### Example 8

| | |
|---|---|
| Glucopon 425N (CAS: 68515-73-1) | 94.8% |
| Tego Sun T 805 G TiO₂ with | 5.1% |
| 10% Trimethoxyoctylsilane (Evonik/Degussa) | |
| (CAS: 13463-67-7) | |
| Vinegar 5% V:V (CAS 64-19-7) | 0.1% |

The Glucopon surfactant is carefully added to the TiO₂ in a closed reactor as to not lose the light and dusty white solid before suspension into the mixture, the mixture is shaken for 0.5 Hour to a more concentrated suspension with an increased viscosity and a 10% volume reduction with the suspension. The vinegar component was added dropwise to acidify the mixture slightly and act as a biocide. The suspension was allowed to stand to eliminate trapped air in the suspension and transferred to a container for later use. The same dilution for cleaning was used as in Example 1.

The above cleaners were mixed in a batch process at room temperature.

The above examples are specific exemplary embodiments of the invention. Other embodiments of the invention are possible. For example, a wide variety of hydrophilic additives (besides those expressly identified herein) can be used.

“Hydrophilic” refers to a physical property of a molecule on a surface that can transiently bond with water (H₂O) through hydrogen bonding which refers to the tendency to attract water in a continuous film with little or no contact angle as described in FIGS. 4 and 5.

Also, while the cleaner may be packaged, presented, and commercialized as a concentrate when sold to consumers, it can also be pre-diluted with water and then sold in various forms, e.g., spray bottles (e.g. as a kitchen surface cleaner).

### INDUSTRIAL APPLICABILITY

A cleaner is provided to clean surfaces, e.g., glass windows, the outsides of vehicles, dishes and flatware, and other hard surfaces, wherein the cleaner creates a thin film that provides continuous cleaning of the surface to which it is applied.

1. A photocatalytic surface cleaning composition comprising about 5 to about 95 wt % surfactant selected from among linear alkoxylated alcohols; and about 0.1 to about 30 wt % nanoparticulate photocatalyst.

2. The composition of claim 1, further comprising 0.01 to about 5 wt % antioxidant.

3. The composition of claim 2, wherein the antioxidant is a polyphenol.

4. The composition of claim 1, wherein the photocatalyst is selected from the group consisting of: TiO₂, ZnO, WO₃, SnO₂, CaTiO₃, Fe₂O₃, MoO₃, Nb₂O₅, Ti_{X}Zr_{(̂X)}O₂, SiC, SrTiO₃, CdS, GaP₅ InP, GaAs, BaTiO₃, KNbO₃, Ta₂O₅, Bi₂O₃, NiO, Cu₂O, SiO₂, MoS₂, InPb, RuO₂, CeO₂, Ti(0H)₄, and combinations thereof.

5. The composition of claim 1, wherein the surfactant is an alkyl polyglycoside at about 70 to about 90 wt %; and the photocatalyst is about 0.5 to about 5 wt %.

6. The composition of claim 5, further comprising about 0.1 to about 3% antioxidant.

7. The composition of claim 5, wherein the photocatalyst is a metal oxide

8. The composition of claim 6, wherein the metal oxide is selected from TiO₂, SiO₂, and combinations thereof.

9. The composition of claim 8, further comprising an organosilane.

10. The composition of claim 9, wherein the metal oxide is surface coated with an alkoxyalkyl silane.

11. The composition of claim 10, wherein the alkoxyalkyl silane is trimethoxyoctyl silane.

12. The composition of claim 5, wherein the pH is adjusted to about 4 to about 6.

13. The composition of claim 5, further comprising an organic solvent.

14. The composition of claim 13, wherein the organic solvent is selected from the group consisting of glycol ethers, C₁-C₈ monohydric alcohols, C₂-C₈ polyhydric alcohols, and combinations thereof.

15. The composition of claim 6, wherein the antioxidant is selected from the group consisting of tannins, lignins, and flavonoids.

16. The composition of claim 15, wherein the flavonoids are selected from the group consisting of flavonols, flavones, catechins, flavanones, anthocyanidins, and isoflavonoids.

17. A method for cleaning surfaces comprising applying to the surface a suspension of a composition comprising about 5 to about 95 wt % carrier; about to about 30 wt % nanoparticles of a photocatalyst; and 0.01 to about 5 wt % antioxidant.

18. The method of claim 17, wherein the suspension is dispersed over the surface and dried to create a solid thin film residue on the surface comprising photocatalyst nanoparticles and antioxidant.
